(19) United States
(12) Patent Application Publication
(10) Pub. No.: US 2018/0060009 A1
(43) Pub. Date: Mar. 1, 2018

(54) MANAGING SECONDARY VIEWS FOR MEETING MANAGEMENT APPLICATIONS IN MULTI-DISPLAY ENVIRONMENTS

(71) Applicant: MICROSOFT TECHNOLOGY LICENSING, LLC, Redmond, WA (US)

(72) Inventor: Kishore Kumar Peshkar, Redmond, WA (US)

(73) Assignee: MICROSOFT TECHNOLOGY LICENSING, LLC, Redmond, WA (US)

(21) Appl. No.: 15/367,197

(22) Filed: Dec. 2, 2016

Related U.S. Application Data
(60) Provisional application No. 62/380,976, filed on Aug. 29, 2016.

(51) Int. Cl. G06F 3/14; G09G 5/12

(52) U.S. Cl. CPC G06F 3/1423; G06F 3/165; G09G 5/12; G06F 3/1407

(57) ABSTRACT

Technologies may be configured to manage a secondary view for a meeting management application in a multi-display environment. In response to detecting an available secondary display device, a secondary view may be created for the detected secondary display device. The detected secondary display device may include a projector, a television, or a monitor in a conference room. In other examples, the created secondary view may be provided to the detected secondary display device. In response to detecting an unavailability of the secondary display device, the secondary view may be consolidated programmatically. In response to detecting consolidation of the secondary view due to a non-display related reason, the secondary view may be re-created upon recovery and provided to the secondary display device.

### CROSS-REFERENCE TO RELATED APPLICATION

This Application claims priority under 35 U.S.C. § 119(e) to U.S. Provisional Patent Application Ser. No. 67/380,976 filed on Aug. 29, 2016. The disclosure of the ILLS Provisional Patent Application is hereby incorporated by reference in its entirety.

### BACKGROUND

Conference rooms may include a projection display or a similar display device for displaying content, projecting online meeting content, and executing other collaborative efforts. Conventional conference room displays may be controlled by a dedicated computer or by a meeting attendant's computing device. As such, display management may be performed through the display management programs in individual computers and/or computing devices.

Modern conference rooms may be equipped with enhanced computing devices to accommodate the increasingly complex needs of physical messages and online meetings, collaboration applications, online content, and additional functionality that users have come to expect. Thus, meeting management applications may coordinate various functionalities associated meeting room operations. Such applications may manage displays, among other components, to address a variety of challenges, such as a number of available displays, when a select display device is available, which display device is available, and/or how content is to be displayed on the select display device, among others.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments directed to managing a secondary view for a meeting management application in a multi-display environment. In response to detecting an available secondary display device, a secondary view may be created for the detected secondary display device. The detected secondary display device may include a projector, a television, or a monitor in a conference room. In other examples, the created secondary view may be provided to the detected secondary display device. In response to detecting an unavailability of the secondary display device, the secondary view may be consolidated programmatically. In response to detecting consolidation of the secondary view due to a non-display related reason, the secondary view may be re-created upon recovery and provide to the secondary display device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example schematic diagram of an example process to manage a secondary view for a meeting management application in a multi-display environment.

FIG. 2 illustrates an example schematic diagram illustrating management of a secondary view for a meeting management application in a multi-display environment;

FIG. 3 illustrates a conceptual diagram of an example process to manage a secondary view for a meeting management application in a multi-display environment;

FIG. 4 is a networked environment, where a system according to embodiments may be implemented;

FIG. 5 is a block diagram of an example general purpose computing device, which may be used to manage a secondary view for a meeting management application in a multi-display environment; and

FIG. 6 includes a logic flow diagram that illustrates a process to manage a secondary view for a meeting management application in a multi-display environment, according to at least some embodiments disclosed herein.

### DETAILED DESCRIPTION

As briefly described above, systems and applications may be configured to manage a secondary view for a meeting management application in a multi-display environment. In response to launching the meeting management application, a first view may be created for the meeting monument application. The first view may display a first content. In response to detecting an available secondary display device, a secondary view may be created for the detected secondary display device. The second view may display a second content.

In some examples, the first content and the second content may be similar content. In other examples, the first content and the second content may be dissimilar content, where the first content may include control functionality for the meeting management application and the second content may include a gallery of online meeting attendants and/or presentation materials. In further examples, the first content and the second content may be provided by an external computing device, the meeting management application, or one or more attendant computing devices, among other examples.

In some examples, the secondary display device may include a projector, a television, or a monitor in a conference room, among other components. In other examples, the created secondary view may be provided to the detected secondary display device. In response to detecting an unavailability of the secondary display device, the secondary view may be consolidated programmatically. In response to detecting consolidation of the secondary view due to a non-display related reason, the secondary view may be re-created upon recovery and provided to the secondary display device.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including band-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can, for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for managing secondary views in meeting room environments. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

The technical advantages of managing a secondary view for a meeting management application in a multi-display environment may include, among others, improved computing device performance, reduced processing and network bandwidth usage associated with a computing device, energy savings associated with the computing device, and improved user interaction by allowing users to find active meeting management user interfaces at all times in the meeting room without having to launch or re-launch the associated systems. Further, productivity and conference-based functionalities (e.g., screen sharing, white-boarding, and video conferencing, etc.) may become more user-friendly.

Embodiments address a need that arises from very large scale of operations created by networked computing and cloud based services that cannot be managed by humans. The actions/operations described herein are not a mere use of a computer, but address results of a system that is a direct consequence of software used as a service such as online meeting services offered in conjunction with physical meeting rooms.

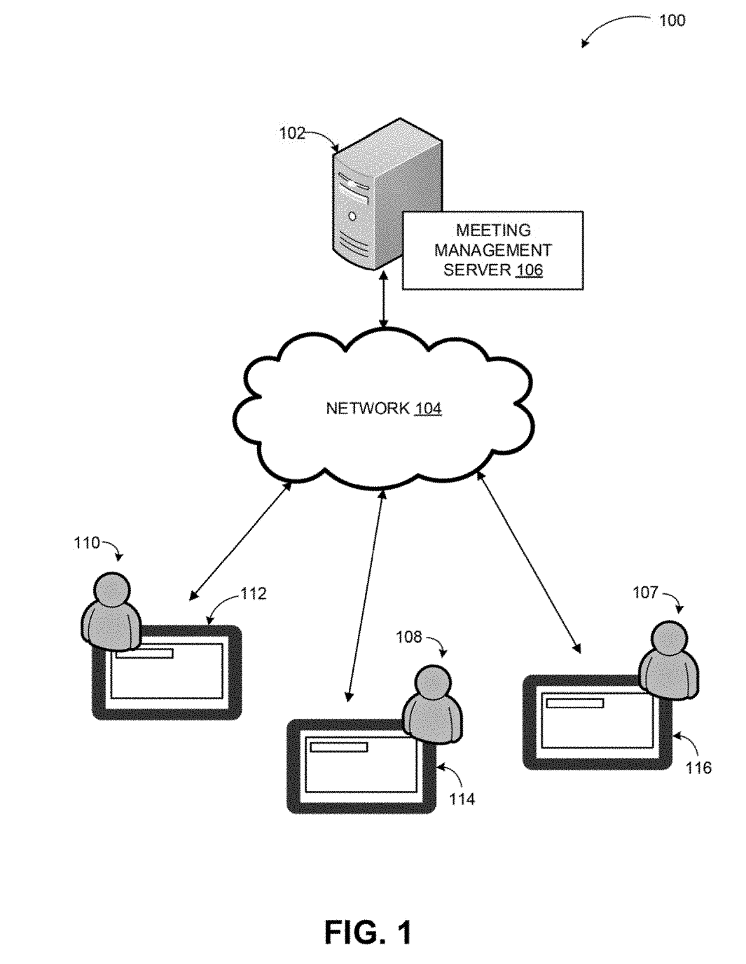

FIG. 1 illustrates an example schematic diagram of an example process to manage a secondary view for a meeting management application in a multi-display environment, according to at least some embodiments disclosed herein.

As illustrated in a diagram 100, an example system may include a meeting management server 106. In some examples, the meeting management server 106 may be configured to interoperate with various applications to synchronize content stored in local storage on client devices (e.g., a first computing device 112, a second computing device 114, and/or a third computing device 116) with the same content stored remotely at the meeting management server 106. The first computing device 112 may be associated with a first participant 110. The second computing device 114 may be associated with a second participant 108. The third computing device 116 may be associated with a third participant 107.

In some examples, the first participant 110 may execute a thin version (e.g., a web browser) of an application through the first computing device 112, the second participant 108 may execute the thin version of the application through the second computing device 114, and/or the third participant 107 may execute the thin version of the application through the third computing device 116. According to sore-le examples, a participant interface may facilitate communication over one car more networks (e.g., a network 104) and between the meeting management server 106 and the application.

The first computing device 112, the second computing device 114, and the third computing device 116 may be a desktop computer, a laptop computer, a tablet computer, a smart phone, a vehicle mount computer, or a wearable computer, among other devices. According to further examples, the first participant 110, the second participant 108, and/or the third participant 107 may execute a thick version (e.g., a locally-installed version) of the application through the first computing device 112, the second computing device 114, and/or the third computing device 116, respectively.

According to other examples, the application may be hosted by a meting management service and the meeting management service may be configured to interact with the application over the network 104. The network 104 may comprise any topology of servers, clients, Internet service providers, and communication media. In some examples, the application may be a productivity application. The productivity application may include a word-processing application, a spreadsheet application, a presentation application, or a notebook application, among other examples. In other examples, the application may be a conference-based application, which mays allow for screen-sharing functionality, white-board functionality, and/or video conferencing, among others. The participant interface may facilitate communication over the network 104 and between the meeting management service and the application.

While the example system in FIG. 1 has been described with specific components, including the meeting management server 106, the network 104, the first participant 110, the second participant 108, the third participant 107, the first computing device 112, the second computing device 114, and the third computing device 116, embodiments are not limited to these components or system configurations and can be implemented with other system configuration employing fewer or additional components.

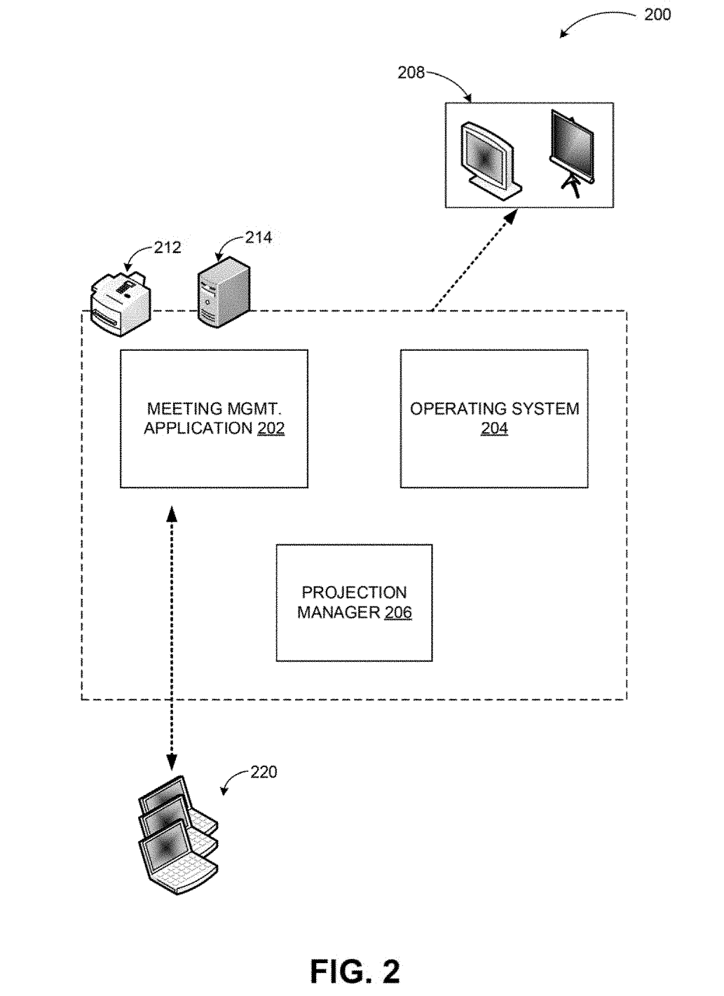

FIG. 2 illustrates an example schematic diagram illustrating management of a secondary view for a meeting management application in a multi-display environment, according to at least some embodiments disclosed herein.

A diagram 200 mar illustrate an example system. The example system may include a computing device 212. The computing device 212 may be configured to manage a secondary view for a meeting management application 202 in a multi-display environment. In some examples, the meeting management application 202 may be a universal platform meeting management application. As such, the meeting management application 202 may be executed on any computing device (e.g., the computing device 212 or a select computing device of the other computing devices 220) and any software platform. Further, the meeting management application 202 may be subject to constraints associated with the software platform the meeting management application 202 is executed on.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed/executed on a desktop platform and a mobile platform. Some universal platform applications may not indicate having been written for a specific operating system or platform in their manifest build; instead, they may target one or more device families, such as a PC, smartphone, tablet, or gaming systems. These extensions may allow the application to automatically utilize the capabilities that are available to the particular device it is currently running on. The platform-agnostic nature of these applications may allow enhanced user experience aspects in addition to efficiency and reduced complexity. For example, a universal platform application executed on a smartphone may start behaving the way it would if it were running on a PC when the smartphone is connected to a desktop computer or a suitable docking station.

The computing device 212 may include a memory, a processor, and/or a projection manager 206, among other components. The memory may include an operating system 204. The memory may be configured to store instructions. The processor may be coupled to the memory. According to some examples, the processor may be configured to execute the meeting management application 202. In response to detecting a secondary display device 208, the meeting management application 202 may be configured to create a secondary view for the secondary display device 208. The secondary display device 208 may include, in a conference room, a projector, a television, a monitor, a wall projection system, a screen mounted onto one or more walls within the meeting room, an interactive floor display, an interactive window display, or an interactive wall display, among other examples.

In some examples, the meeting management application 202 may be configured to provide the created secondary view to the secondary display device 208. In response to detecting an unavailability of the secondary display device 208, the meeting management application 202 may be further configured to consolidate the secondary view programmatically. In response to detecting consolidation of the secondary view due to a non-display related reason (e.g., a crash of the system or a crash of the meeting management application 202), the meeting management application 202 may be further configured to recreate the secondary view upon recovery and provide to the secondary display device 208.

As described herein, “programmatically” may refer to manipulation of an application package (e.g., a meeting management application package). In some examples, the application package may be created dynamically. In other examples, the application package may be managed and executed outside of a development environment. In further examples, manipulation of the application package may include loading and executing the application package without modification. In other examples, manipulation of the application package may include loading the application package, reconfiguring the application package (e.g., for a different data source), and executing the application package. Further, manipulation of the application package may include creating a new application package, where components may be added and configured object by object and property by property. The new packaged application may be saved and executed.

A typical application interfaces with humans through a visual user interface displayed on a monitor or similar display device. Visual user interfaces may be augmented or accompanied by audio (e.g., text-to-speech and voice recognition), gesture recognition, tactile feedback, and similar technologies. However, visual user interfaces are the main, interface mechanism for vast majority of software applications. Similarly, typical applications are configured for a single display, that is, the user interface is set up to be displayed on a single display device. Increasingly, however, multiple displays are being used for a variety of purposes ranging from gaming to business uses. For example, it is becoming increasingly common for people to use two monitors at their work station and split various applications between the two monitors.

Management of multiple display devices may take different forms. The basic and simplest form is duplication of the same user interface(s) on multiple devices (e.g., for coverage of larger audiences). Another common form is spanning (horizontal or vertical) the user interface(s) across multiple display devices. This is also called extended view, where the desktop, user interfaces for multiple applications, and other elements such as file or folder icons, etc. may be distributed across multiple display devices. While simple duplication may be accomplished by mechanical means such as splitting the connections physically, spanning or extended views need to be created programmatically either by the application itself or by an associated program and/or device such as a graphics processor or accelerator.

With multiple displays, each screen may have its own graphics buffer. In one example scenario of programmatically creating the extended view, a continuous, virtual frame buffer may be presented in which the operating system or a graphics driver writes out to each individual buffer. In other examples, a mode called horizontal span may be employed, where the user interface(s) and other elements may be rendered to a very large frame buffer for output. In a further example, visualization data may be shared across multiple graphical processing units and rendered to each individual display device's frame buffer.

A meeting management application according to embodiments may generate two or more separate views for two or more display devices. Based on default configuration or user customization these views may be the same or distinct. Thus, at runtime, the meeting management application is generating (to be rendered) multiple views and managing changes to user interfaces displayed in those views. These programmatically generated views may consume memory and processing resources. In some cases, one or more of the display devices may be taken offline, for example, turned off eliminating a need for a view corresponding to the offline display device. In such scenarios, the meeting management application may programmatically (in executed code) consolidate the views thereby preserving memory and processing resources. In other examples, the meeting management application or the underlying operating system may be turned off due to a crash or similar reason. In such scenarios, the user(s) may prefer to have the same views available on the corresponding display devices upon recovery. Thus, the meeting management application may re-generate the same views upon recovery (not consolidate the views programmatically upon reset) such that the meeting can continue without major interruption (e.g., users having to reconfigure the views).

According to further examples, the projection manager 206 may be configured to manage rendering of provided content on the secondary display device 208. One or more of the meeting management application 202, the operating system 204, and projection manager 206 may be executed on a special purpose device (e.g., the computing device 212) and/or a server 214. In further examples, the meeting management application 202 may be further configured to receive content to be presented in the meeting room (e.g., from one or more of the other computing devices 220) and/or a communications input associated with audio data to be presented in the meeting room based on the activity within the meeting room/conference room.

According to further examples, the meeting management app cation 202 may be further configured to display messages in real-time on the secondary display device 208 in response to detecting creation of the secondary view. A textual scheme, a graphical scheme, an audio scheme, an animation scheme, a coloring scheme, a highlighting scheme, and/or a shading scheme may be employed to further enhance user interaction with a client interface of the meeting management application 202 or a meeting management service. In some examples, the messages may prompt meeting attendants to provide user-definable input into the messages.

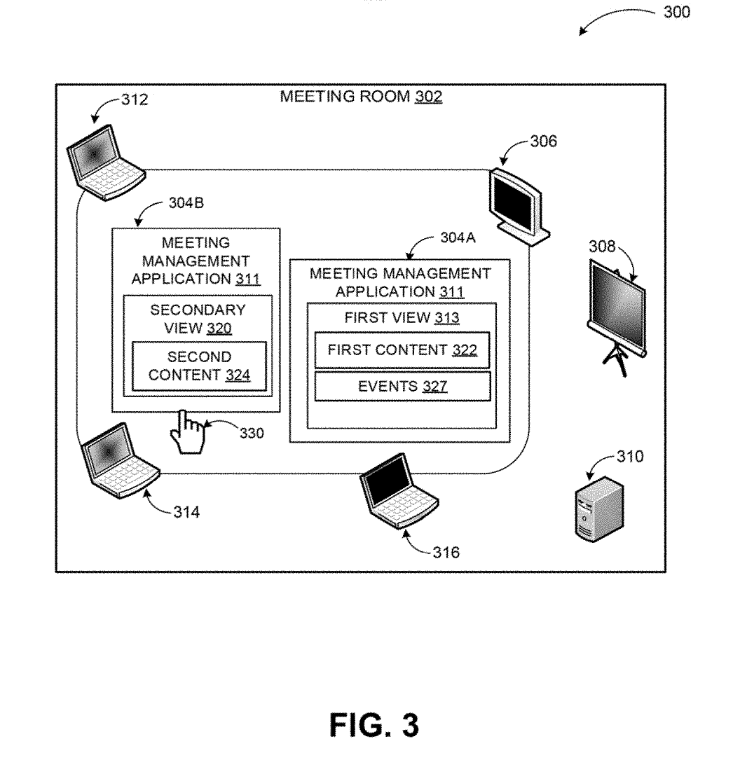

FIG. 3 illustrates a conceptual diagram of an example process to manage a secondary view for a meeting management application in a multi-display environment, according to at least some embodiments disclosed herein.

As shown in diagram 300, a meeting management application 311 may be executed on a server 310 or a special purpose device (e.g., a computing device 304A or a computing device 304B) in a meeting room 302. The meeting room 302 may include a secondary display device 308, such as a wall projection system, a desktop monitor 306, and/or other computing devices. According to some embodiments, meeting content may be provided by the meeting management application 311, by one or more attendant computing devices 312, 314, 316, or by an external computing device. The one or more of the attendant computing devices 312, 314, and 316 may also be used as the secondary display device 308.

According to some examples, when the meeting management application 311 is launched, a first view/a main view 313 for the meeting management application 311 may be created by default. If and when the secondary display device 308 is detected as available, a corresponding secondary view may be created and provided to the secondary display device 308 through wired means or wireless means. In some examples, the secondary display device 308 may include a projector, a television, or a monitor in a conference room. In other examples, the first view 313 may display a first content 322 and the second view 320 may display a second content 324. In further examples, the first content 322 and the second content 324 may be similar content.

In other examples, the first content 322 and the second content 324 may be dissimilar content, where the first content 322 may include control functionality for the meeting management application 311. The control functionality may enable one or more participants/meeting attendants to add, modify, and/or delete the meeting content. The second content 324 may include a gallery of online meeting attendants and/or presentation materials (e.g., textual content, audio content, graphical content, and/or video content, etc.).

In other examples, the meeting management application 311 may maintain a main view user interface (UI) thread. The main view UI thread may register events 327 for available secondary display device 308 and may allow=the meeting management application 311 to react to those events 327. For example, if the secondary display device 308 is disconnected, the corresponding secondary display view may be consolidated programmatically at the meeting management application 311. When the secondary display device 308 becomes available again, the corresponding secondary view may be re-created and provided to the secondary display device 308. If the secondary view is closed for a reason unrelated to the secondary display device 308, such as a system crash, a crash of the meeting management application 311, or any operating system fault with the secondary display device 308 still available, the meeting management application 311 may re-create the secondary display view upon recovery and provide it to the secondary display device 308.

In other examples, in response to the main view UI thread registering the events 327 for the secondary display device 308 for display, a participant may be prompted to: accept one or more of the events 327, reject one or more of the events 327, and/or modify one or more of the events 327. In response to receiving a participant response 330 through the meeting management application 311, the meeting management application 311 may be further configured to modify the secondary view and provide the modified secondary view to the detected secondary display device 308.

The examples provided in FIG. 1 through FIG. 3 are illustrated with specific systems, services, applications, modules, and notifications. Embodiments are not limited to environments according to these examples. Embodiments to manage a secondary view for a meeting management application 311 in a multi-display environment may be implemented in environments employing fewer or additional systems, services, applications, engines, modules, and notifications. Furthermore, the example systems, services, applications, engines, modules, and notifications shown in FIG. 1 through FIG. 3 may be implemented in a similar manner with other values using the principles described herein.

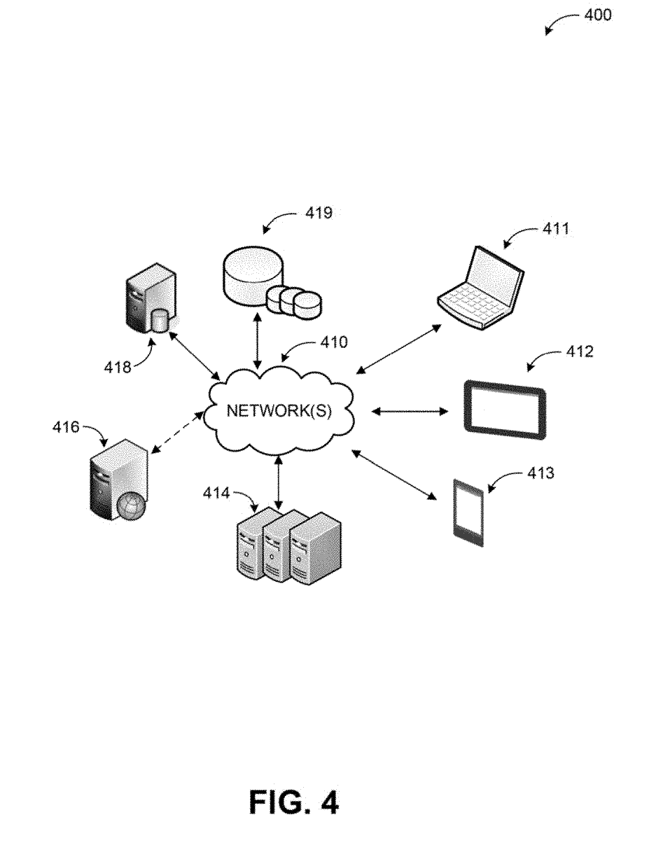

FIG. 4 is a networked environment, where a system according to embodiments may be implemented.

As shown in a diagram 400, a conference room management or meeting management service may be configured to manage a secondary view for a meeting management application in a multi-display environment. In some examples, the conference room management or meeting management service may be implemented in a networked environment over one or more networks, such as network 410. Participants may access the conference room management or meeting management service through locally, installed client applications (e.g., the meeting management application) or thin e.g., browser-based) client applications executed on a variety of computing/client devices (e.g., a laptop 411, a tablet 412, and/or smartphone 413, etc.). Functionality within the conference room management or meeting management service may be provided by a communication module or a communication application executed within the conference room management or meeting management service executed on servers 414 or processing server 416.

The conference room management or meeting management service, as discussed herein, may be implemented via software executed over servers 414. The servers 414, may include one or more processing server 416, where at least one of the one or more processing servers 416 may be configured to execute one or more applications associated with the conference room management or meeting management service. The conference room management or meeting management service may store data associated with a meeting in a data store 419 directly or through a database server 418.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

Many other configurations of computing devices, applications, engines, modules, data sources, and data distribution systems may be employed to manage a secondary view for a meeting management application in a multi-display environment. Furthermore, the networked environments discussed in FIG. 4 are for illustration purposes only. Embodiments are not limited to the example applications, modules, engines, or processes.

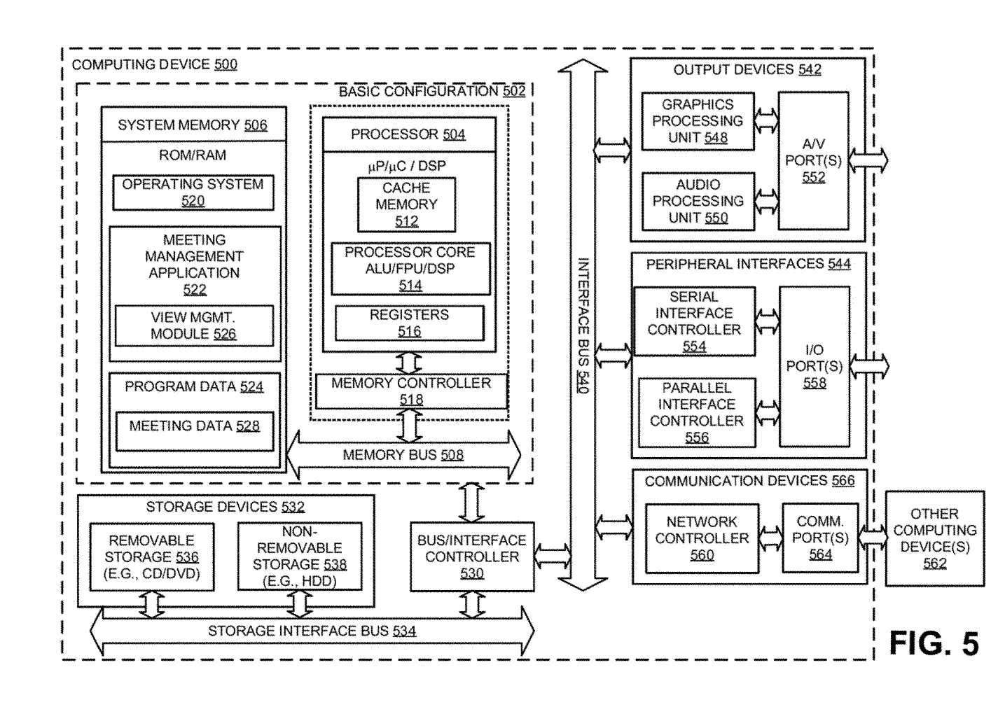

FIG. 5 is a block diagram of an example general purpose computing device, which may be used to manage a secondary view for a meeting management application in a multi-display environment, according to at least some embodiments described herein.

For example, a computing device 500 may be used as a server, a desktop computer, a portable computer, a smart phone, a special purpose computer, or a similar device. In an example, basic configuration 502, the computing device 500 may include one or more processors 504 and a system memory 506. A memory bus 508 may be used for communicating between the processor 504 and the system memory 506. The example basic configuration 502 is illustrated in FIG. 5 by those components within the inner dashed line.

Depending on the desired configuration, the processor 504 may be of any type, including but not limited to a microprocessor (μP), a microcontroller (μC)., a digital signal processor (DSP), or any combination thereof. The processor 504 may include one more levels of caching, such as a level cache memory 512, one or more processor cores 514, and registers 516. The one or more processor cores 514 may (each) include an arithmetic logic unit (ALU), a floating point unit (FPU), a digital signal processing core (DSP Core), or any combination thereof. An example memory controller 518 may also be used with the processor 504, or in some implementations the example memory controller 518 may be an internal part of the processor 504.

Depending on the desired configuration, the system memory 506 may be of any type including but not limited to volatile memory (such as RAM) and non-volatile memory (such as ROM, flash memory, etc.), or any combination thereof. The system memory 506 may include an operating system 520, a meeting management application 522, and program data 524. In response to detecting an available secondary display device, the meeting management application 522 may be configured to create a secondary view for the detected secondary display device. The detected secondary display device may include a projector, a television, or a monitor in a conference room. The meeting management application 522 may also be configured to provide the created secondary view to the detected secondary display device. In response to detecting an unavailability of the secondary display device, the meeting management application 522 may be further configured to consolidate the secondary view programmatically. In response to detecting consolidation of the secondary view due to a non-display related reason, the meeting management application 522 may be configured to recreate the secondary view upon recovery and provide to the secondary display device. In additional examples, the meeting management application 522 may include a view management module 526. The view management module 526 may monitor, analyze, and assist in providing the first view and the secondary view to the detected display device. The program data 524 may include data from the meeting (e.g., meeting data 528) and/or data received from other computing devices.

The computing device 500 may have additional features or functionality, and additional interfaces to facilitate communications between the example basic configuration 502 and any desired devices and interfaces. For example, a bus/interface controller 530 may be used to facilitate communications between the example basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and an example communication device 546) to the example basic configuration 502 via the bus/interface controller 530. Some of the one or more output devices 542 may include a graphics processing unit 548 and an audio processing unit 550, which may be configured to communicate with various external devices, such as a display or speakers via one or more A/V ports 552. The one or more peripheral interfaces 544 may include a serial interface controller 554 or a parallel interface controller 556, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 558. The example communication device 546 may include a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

The computing device 500 may be implemented as a part of a general purpose or a specialized server, a mainframe, or similar computer that includes any of the above functions. The computing device 500 may also be implemented as a personal computer, including both laptop computer configurations and non-laptop computer configurations.

Example embodiments may also include methods to manage a secondary view for a meeting management application in a multi-display environment. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

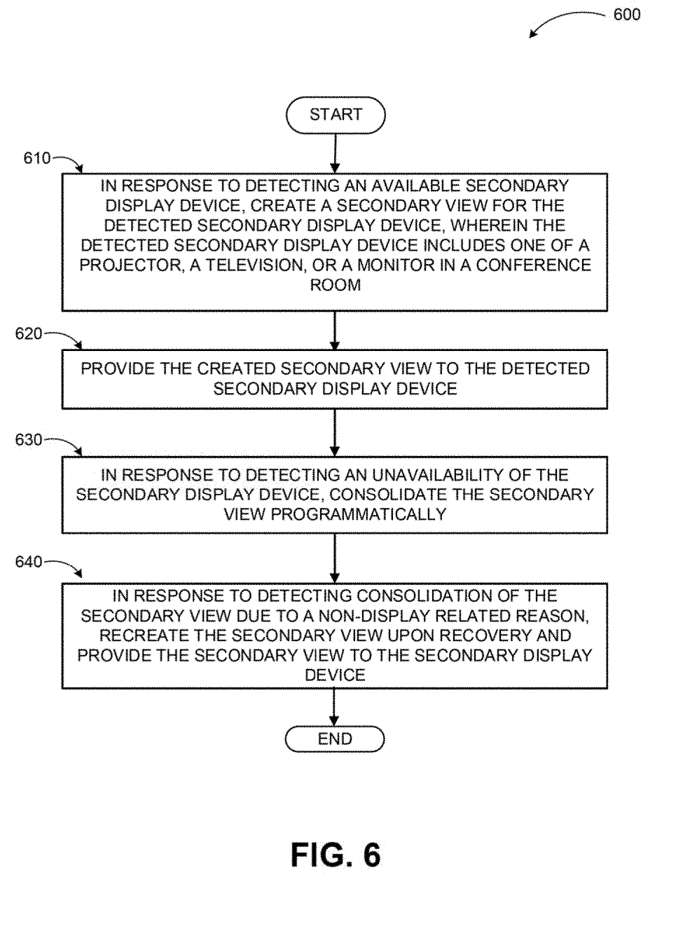

FIG. 6 includes a logic flow diagram that illustrates a process to manage a secondary view for a meeting management application in a multi-display environment, according to at least some embodiments disclosed herein.

Process 600 may be implemented on a computing device, server, or other system. An example computing device may include a memory and/or a processor, among other components. The memory may be configured to store instructions. The processor may be coupled to the memory. The processor may be configured to execute the meeting management application.

Process 600 begins with operation 610, where, in response to detecting an available secondary display device, the meeting management application may be configured to create a secondary view for the detected secondary display device. The detected secondary display device may include a projector, a television, or a monitor in a conference room. In some examples, in response to launching the meeting management application, the meeting management application may be further configured to create a first view for the meeting management application. The first view may display a first content and the second view may display a second content.

In additional examples, the first content and the second content may be similar content. In further examples, the first content and the second content may be dissimilar content, with the first content including control functionality for the meeting management application and the second content including a gallery of online meeting attendants and/or presentation materials. In other examples, the first content and the second content may be provided by one of: an external computing device, the meeting management application, and one or more attendant computing devices. In additional examples, the one or more of the attendant computing devices may include one or more secondary display devices.

Operation 610 may be followed by operation 620, where the meeting management application may be further configured to provide the created secondary view to the detected secondary display device. Operation 620 may be followed by operation 630, where, in response to detecting an unavailability of the secondary display device, the meeting management application may be further configured to consolidate the secondary view programmatically.

Operation 630 may be followed by operation 640, where, in response to detecting consolidation of the secondary view due to a non-display related reason, the meeting management application may be further configured to recreate the secondary view upon recovery and provide the secondary view to the secondary display device. In some examples, the secondary display device may include a wall projection system or a desktop monitor. In further examples, the meeting management application may be further configured to display one or more messages in real-time on the secondary display device in response to detecting creation of the secondary view.

The operations included in process 600 are for illustration purposes. Managing a secondary view for a meeting management application in a multi-display environment may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, a means for managing a secondary view for a meeting management application in a multi-display environment may be described. In some examples, in response to detecting an available secondary display device, a means for creating a secondary view for the detected secondary display device may be described. Further, a means for providing the created secondary view to the detected secondary display device may be described. In response to detecting an unavailability of the secondary display device, a means for consolidating the secondary view programmatically may be described. Additionally, in response to detecting consolidation of the secondary view due to a non-display related reason, a means for recreating the secondary view upon recovery and providing the secondary view to the secondary display device may be described.

According to further embodiments, a method to manage a secondary view for a meeting management application in a multi-display environment may be described. In response to detecting an available secondary display device, the method may include creating a secondary view for the detected secondary display device. In some examples, the method may include providing the created secondary view to the detected secondary display device. In response to detecting an unavailability of the secondary display device, the method may further include consolidating the secondary view programmatically. In response to detecting consolidation of the secondary view due to a non-display related reason, the method may additionally include recreating the secondary view upon recovery and providing the secondary view to the secondary display device.

According to additional embodiments described herein, the detected secondary display device may include a projector, a television, or a monitor in a conference room. According to some additional examples, the method may further include, in response to launching the meeting management application, creating a first view for the meeting management application. The first view may display a first content, The second view may display a second content. The first content and the second content may be similar content

According to other embodiments, the first content and the second content may be dissimilar content. In some examples, the first content may include control functionality for the meeting management application and the second content may include a gallery of online meeting attendants and/or presentation materials. In other examples, the first content and the second content may be provided by an external computing device, the meeting management application, or an attendant computing devices. The attendant computing devices may include secondary display devices, in some examples.

According to some examples, the unavailability of the second display device may include the second display device being powered off. In further examples, the method may further include detecting a closure of the secondary view due to a system crash, a crash of the meeting management application, and/or an operating system fault with the secondary display device, among other examples. The method may further include, in some examples, recreating the secondary view upon recovery and providing the secondary view to the secondary display device to display.

According to additional examples, the method may further include maintaining a user interface (UI) thread for a first view of the meeting management application and enabling the UI thread to register events for the secondary display device. According to some examples, the method may further include providing the events to the secondary display device for display, prompting a participant to one of accept the events, reject the events, and modify the events, and in response to receiving a participant response through the meeting management application, enabling the meeting management application to: modify the secondary view and provide the modified secondary view to the detected secondary display device. In additional examples, the meeting management application may be a universal platform application executed on a server.

According to some examples, a computing device configured to manage a secondary view for a meeting management application in a multi-display environment may be described. The computing device may include a memory and a processor. The memory may be configured to store instructions. The processor may be coupled to the memory. The processor may be configured to execute the meeting management application. The meeting management application may be configured to, in response to detecting an available secondary display device, create a secondary view for the detected secondary display device. The detected secondary display device may include a projector, a television, or a monitor in a conference room. In additional examples, the meeting management application may be further configured to provide the created secondary view to the detected secondary display device. In response to detecting an unavailability of the secondary display device, the meeting management application may be configured to consolidate the secondary view programmatically. In response to detecting consolidation of the secondary view due to a non-display related reason, the meeting management application may be further configured to recreate the secondary view upon recovery and provide the secondary view to the secondary display device.

According to additional examples, the meeting management application may be configured to manage operations associated with meeting content in the conference room. The meeting content includes audio content and/or video content. The operations may include recording a meeting, managing audio controls during the meeting, managing video controls during the meeting, managing online attendants during the meeting, and/or managing presented content during the meeting. The available secondary display device may include one of a wall projection system and a desktop monitor. The meeting management application may be further configured to display messages in real-time on the secondary display device in response to detecting creation of the secondary view.

According to some examples, a computer-readable memory device with instructions stored thereon to manage a secondary view for a meeting management application in a multi-display environment may be described. In response to detecting an available secondary display device, the instructions may include creating a secondary view for the detected secondary display device. The detected secondary display device may include a projector, a television, and/or a monitor in a conference room. The instructions may further include providing the created secondary view to the detected secondary display device. In response to detecting an unavailability of the secondary display device, the instructions may further include consolidating the secondary view programmatically. In response to detecting consolidation of the secondary view due to a non-display related reason, the instructions may further include recreating the secondary view upon recovery and providing the secondary view to the secondary display device.

According to further examples, in response to launching the meeting management application, the instructions may further include creating a first view for the meeting management application. The first view may include a first content. The second view may include a second content. The first content and the second content may be dissimilar content. The first content may include control functionality for the meeting management application. The second content may include a gallery of online meeting attendants and/or presentation materials.

According to some examples, the instructions may further include detecting a closure of the secondary device due to a system crash, a crash of the meeting management application, and/or an operating system fault with the secondary display device. The instructions may further include recreating the secondary view upon recovery and providing the secondary view to the secondary display device to display. According to further examples, the instructions may further include maintaining a user interface (UI) thread for a first view of the meeting management application, enabling the UI thread to register events for the secondary display device, and providing the events to the secondary display device for display. The instructions may further include prompting a participant to one of: accept the events, reject the events, and modify the events. In response to receiving a participant response through the meeting management application, the instructions may further include enabling the meeting management application to: modify the secondary view and provide the modified secondary view to the detected secondary display device.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to manage a secondary view for a meeting management application in a multi-display environment, the method comprising:
in response to detecting an available secondary display device, creating a secondary view for the detected secondary display device;
providing the created secondary view to the detected secondary display device;
in response to detecting an unavailability of the secondary display device, consolidating the secondary view programmatically; and
in response to detecting consolidation of the secondary view due to a non-display related reason, recreating the secondary view upon recovery and providing the secondary view to the secondary display device.

2. The method of claim 1, wherein the detected secondary display device includes one of a projector, a television, or a monitor in a conference room.

3. The method of claim 1, further comprising:
in response to launching the meeting management application, creating a first view for the meeting management application,
wherein the first view displays a first content, and
wherein the second view displays a second content.

4. The method of claim 3, wherein the first content and the second content are similar content.

5. The method of claim 3, wherein:
the first content and the second content are dissimilar content,
the first content includes control functionality for the meeting management application, and
the second content includes one or more of a gallery of online meeting attendants and one or more presentation materials.

6. The method of claim 3, wherein the first content and the second content are provided by one of an external computing device, the meeting management application, and one or more attendant computing devices.

7. The method of claim 6, wherein the one or more of the attendant computing devices include one or more secondary display devices.

8. The method of claim 1, wherein the unavailability of the second display device includes the second display device being powered off.

9. The method of claim 1, further comprising:
detecting a closure of the secondary view due to one or more of: a system crash, a crash of the meeting management application, and an operating system fault with the secondary display device;
recreating the secondary view upon recovery; and
providing the secondary view to the secondary display device to display.

10. The method of claim 1, further comprising:
maintaining a user interface (UI) thread for a first view of the meeting management application; and
enabling the UI thread to register one or more events for the secondary display device.

11. The method of claim 10, further comprising:
providing the one or more events to the secondary display device for display;
prompting a participant to one of: accept the one or more events, reject the one or more events, and modify the one or more events; and
in response to receiving a participant response through the meeting management application, enabling the meeting management application to:
modify the secondary view; and
provide the modified secondary view to the detected secondary display device.

12. The method of claim 1, wherein the meeting management application is a universal platform application.

13. A computing device configured to manage a secondary view for a meeting management application in a multi-display environment, the computing device comprising:
a memory configured to store instructions;
a processor coupled to the memory, the processor configured to execute the meeting management application, wherein the meeting management application is configured to:
in response to detecting an available secondary display device, create a secondary view for the detected secondary display device, wherein the detected secondary display device includes one of a projector, a television, or a monitoring a conference room;
provide the created secondary view to the detected secondary display device;
in response to detecting an unavailability of the secondary display device, consolidate the secondary view programmatically; and
in response to detecting consolidation of the secondary view due to a non-display related reason, recreate the secondary view upon recovery and provide the secondary view to the secondary display device.

14. The computing device of claim 13, wherein the meeting management application is further configured to:
manage operations associated with meeting content in the conference room, wherein:
the meeting content includes one or more of: audio content and video content, and
the operations include one or more of: recording a meeting, managing audio controls during the meeting, managing video controls during the meeting, managing online attendants during the meeting, and managing presented content during the meeting.

15. The computing device of claim 13, wherein the available secondary display device includes one of a wall projection system and a desktop monitor.

16. The computing device of claim 13, wherein the meeting management application is further configured to:
display one or more messages in real-time on the secondary display device in response to detecting creation of the secondary view.

17. A computer-readable memory device with instructions stored thereon to manage a secondary view for a meeting management application in a multi-display environment, the instructions comprising:
in response to detecting an available secondary display device, creating a secondary view for the detected secondary display device, wherein the detected secondary display device includes one of a projector, a television, or a monitor in a conference room;
providing the created secondary view to the detected secondary display device;
in response to detecting an unavailability of the secondary display device, consolidating, the secondary view programmatically; and
in response to detecting consolidation of the secondary view due to a non-display related reason, recreating the secondary view upon recovery and providing the secondary view to the secondary display device.

18. The computer-readable memory device of claim 17, wherein the instructions further comprise:
in response to launching the meeting management application, creating a first view for the meeting management application, wherein
the first view includes a first content,
the second includes a second content,
the first content and the second content are dissimilar content,
the first content includes control functionality for the meeting management application, and
the second content includes one or more of a gallery of online meeting attendants and one or more presentation materials.

19. The computer-readable memory device of claim 17, wherein the instructions further comprise:
detecting a closure of the secondary device due to one or more of: a system crash, a crash of the meeting management application, and an operating system fault with the secondary display device;
recreating the secondary view upon recovery; and
providing the secondary view to the secondary display device to display.

20. The computer-readable memory device of claim 17, wherein the instructions further comprise:
maintaining a user interface (UI) thread for a first view of the meeting management application;
enabling the UI thread to register one or more events for the secondary display device;
providing the one or more events to the secondary display device for display;
prompting a participant to one of: accept the one or more events, reject the one or more events, and modify the one or more events; and
in response to receiving a participant response through the meeting management application, enabling the meeting management application to:
modify the secondary view; and
provide the modified secondary view to the detected secondary display device.
